(19) United States
(12) Patent Application Publication
(10) Pub. No.: US 2024/0087758 A1
(43) Pub. Date: Mar. 14, 2024

(54) Method and Device for Energy Production and Synthesis of Rare Metals by Transmutation and Nuclear Fusion

(71) Applicants: Morou Boukari, Toulouse (FR); PRODOSE, Bessieres (FR)

(72) Inventor: Morou Boukari, Toulouse (FR)

(21) Appl. No.: 18/274,927

(22) PCT Filed: Jan. 28, 2022
(86) PCT No.: PCT/FR2022/050162

§ 371 Date: Sep. 26, 2023

Related U.S. Application Data
(60) Provisional application No. 63/280,954, filed on Nov. 18, 2021.
(60) Provisional application No. 63/213,881, filed on Jun. 23, 2021.
(60) Provisional application No. 63/193,232, filed on May 26, 2021.
(60) Provisional application No. 63/155,469, filed on Mar. 2, 2021.
(60) Provisional application No. 63/143,443, filed on Jan. 29, 2021.

(51) Int. Cl. G21B 1/15

(52) U.S. Cl. CPC G21B 1/15; G21B 1/19

(57) ABSTRACT

A method for producing energy and synthesizing chemical elements, including rare metals, is remarkable in that it consists in creating particular conditions inside an enclosure in which a first gas or gas mixture is present by projecting a jet of a second gas or gas mixture on the internal wall of the enclosure. This projection under these conditions results in the creation of a plasma and, in the impact area and at its periphery, to transmutation reactions and, depending on the material of the impact area, to nuclear fusion reactions and synthesis of chemical elements reproducing characteristics equivalent to those of a black hole. A device allowing implementing the method of the invention is also described.

### FIELD OF TECHNOLOGY

The invention relates to the field of energy production and of synthesis of chemical elements and in particular to adaptations allowing creating conditions equivalent to those of a black hole for the purposes of production of energy and production of chemical elements such as rare metals.

### BACKGROUND

A possible definition of a black hole is that of a dense object (body) surrounded by an area of swirling ionised hot gas called the accretion area, an area in which nuclear fusion and transmutation reactions of chemical elements occur.

There are many other definitions of the black hole.

For some, a black hole is a celestial object so compact that the intensity of its gravitational field prevents any form of matter or radiation from escaping from it.

Such objects can neither emit nor scatter light and are therefore black, which in astronomy means that they are optically invisible.

For others, like Hawking, a black hole could emit radiation.

While till now no one has been able to directly observe a black hole, nor know what is really happening inside this black hole, several indirect observation techniques in different wavelengths have been developed and allow studying many phenomena induced thereby. In particular, the matter trapped in a black hole, swirling around it and the site of numerous nuclear fusion and transmutation reactions is heated up to very high temperatures and emits a large amount of radiations.

Because of the observation difficulties, the definition of a black hole might diverge.

Demonstrating the actual presence of a black hole may also involve indirect photography and the comparison with the photographs that could be taken of a black hole.

In addition, while the creation of a black hole in the laboratory has been the subject of a plurality of attempts, these have so far not been successful.

Indeed, in theory, the necessary amount of energy is much higher than that likely to be implemented by the human being. Yet, since this theory is not capable of determining:
what actually happens inside a black hole,
the creation of a black hole,
the real composition of a black hole.

Trying to reproduce a black hole in the laboratory from this theory could only lead to failure. It should also be noted that the nuclear reactions that take place in space inside the celestial bodies depend enormously on the state (gaseous, solid or dust) and on the density of the celestial body.

Depending on the state and density of the body, nuclear fusion, pycnonuclear, transmutation reactions may occur at very low temperatures even at temperatures comprised between 230 and 2,000° C. (case of brown dwarfs).

Similarly, in black dwarfs, which are celestial bodies that have not yet been directly observed, the possibility of a transmutation reaction at zero degree is considered.

Thus, density is a key parameter of the capacity to be able to create the conditions equivalent to those of a black hole and therefore a black hole.

### SUMMARY OF THE DISCLOSURE

The Applicants have conducted research in the field of energy production, synthesis of chemical elements (chemical substances) and production of chemical elements such as rare metals, which research has led to the creation of conditions equivalent to those of a black hole and therefore of a black hole. It has been possible to notice this creation by observing transmutation and fusion reactions. This research has been based on the study of the operation of a turbine or reactor type device the implementation of which under particular conditions and the observation of which have allowed defining the invention in the form of a method and then of a device for transmutation and nuclear fusion and therefore for the creation of a black hole. Another object of the invention consists of the applications of these method and device.

According to the invention, the method for energy production and chemical element synthesis is remarkable in that it comprises the following operations:
providing an enclosure comprising walls with internal and external surfaces,
providing a first hot gas or gaseous mixture inside the enclosure,
providing in the form of a jet inside the enclosure a second gas or gaseous mixture under pressure whose temperature is lower than that of the first gas or gaseous mixture in the enclosure,
Accelerating the second gas or gaseous mixture through a sudden increase in their temperature when the jet comes out into the heated enclosure,
Ionising the jet of the second gas or gaseous mixture by friction between the gas jet of the second gas or gaseous mixture and the first hot gas or gaseous mixture contained in the enclosure, the ionisation creating a first plasma,
Projecting the jet of the second ionised gas or gaseous mixture on the internal surface of a wall of the enclosure so as to form a swirling area of ionised gas at the periphery of the impact area of the jet of second gas on the wall of the enclosure,
Creating shocks and collisions between the molecules and atoms of the jet of the second gas or gaseous mixture and the atoms of the material forming the impact area and its periphery with:
a) a diffusion of part of the atoms and gas projected inside the material forming the impact area and its periphery with a creation of shocks and collisions between the molecules and atoms and the nuclei of the atoms of the jet of the second gas or gaseous mixture and the atoms and the nuclei of the atoms of the material composing the impact area and its periphery,
b) A creation of secondary jets of a second hot plasma in the form of an ionised gas containing atoms of the material composing the impact area and its periphery and the atoms and molecules derived from the jet of the second gas or gaseous mixture,
c) A projection of the secondary jets of the plasma on the walls of the enclosure inside the latter with a creation of shocks and collisions between the molecules, atoms and nuclei of the atoms of the gas jets and the atoms and nuclei of the atoms of the material composing the enclosure,
Creating transmutation reactions, and
depending on the material of the impact area and its periphery, creating nuclear fusion reactions, and
synthesising chemical elements resulting from the shocks and collisions between the molecules, atoms and nuclei of the atoms of the gas jets and the atoms and nuclei of the atoms of the material of the impact area and its periphery defined in the enclosure.

According to the observations of the Applicants, the reactions in presence are characteristic of those of a black hole. The impact area or point makes up the centre of the black hole and its periphery makes up the accretion area which is a radiation source.

Thus, at said accretion area, a release of heat and the emission of light radiation are observed.

This heat release and these radiation emissions are the consequence of transmutation, nuclear fusion, pycnonuclear and nucleosynthesis, reactions. Pycnonuclear fusion is a fusion in a dense medium. Nucleosynthesis is the consequence of fusions and transmutations.

Nuclear fusion, pycnonuclear, nucleosynthesis and transmutation reactions are promoted by the tunnel effect.

The acceleration of the molecules of the gas and/or of the particles contained in the jet of the second gas or gaseous mixture through a sudden increase in their temperature when the jet comes out into the enclosure results in an increase in the speed of the molecules of the gas and/or of the particles contained in the jet(s) of the second gas by a factor of 3 to 100 depending on the temperature in the enclosure.

The wall of the enclosure is thin, this wall may become transparent and allows seeing with the naked eye the swirling movement of the ionised hot gas around the impact point of the jet (impact point forming the black hole).

This heat and this radiation may be exploited for a plurality of applications.

Thus, according to a feature of the invention, the energy contained in the black hole and its surroundings (accretion area or disc and other areas after the accretion area starting from the centre of the black hole), is in the form of:
i. o Thermal radiation,
ii. o Heat,
iii. o Light radiation or light (visible, infrared, ultraviolet, X-rays),
iv. o Alpha and/or beta and/or gamma radiation
v. o Plasma,
vi. o Photons,
vii. o Charged particles,
viii. o Uncharged particles
ix. o Neutrons
x. o Combustion gas

According to another feature of the invention, the energy is extracted from the black hole into:
xi. o Electrical energy,
xii. o Mechanical energy,
xiii. o Heat.

The extracted energy may be used to propel aerial, space, land and maritime vehicles. They may also be used in industrial and/or domestic applications.

According to another feature of the invention, at least one of the following chemical elements Fe, Co, Sb, Sn, Sr, P, S, Ti, Mg, Zn, Al, V, Ti, Ir, Rh, Rb, is synthesised.

According to another feature of the invention, the following effects may be used to extract energy:
a.—Thomson effect and/or
b.—Seebeck effect and/or
c.—Peltier effect.

According to a preferred yet non-limiting embodiment, the speed of the second gas forming the jet is higher than 30 m/s or higher than 50 m/s or higher than 100 m/s or higher than 150 m/s or higher than 200 m/s or higher than 300 m/s or higher than 400 m/s or higher than 500 m/s or higher than 1,000 m/s. The speed may range up to 5,000 m/s.

These speeds are those implemented at the jet before acceleration thereof.

The impact of the jet of the second accelerated gas on the wall of the enclosure (which enclosure is called reactor or combustion chamber) results in a very significant increase in the pressure on the impact area and its surroundings, which could reach 50 to 1,000 bars (50 to 1,000 Kg/cm2). This may be locally reflected by an increase in the density of the material to values from 10,000 to 20,000,000 g/cm3. This higher density is obtained because of the pressure exerted by the jet.

According to another particularly advantageous feature of the invention, the second gas forming the jet(s) (fresh or hot gas at the jet nozzle outlet) is selected from the following list:
air,
oxygen,
nitrogen,
carbon monoxide,
carbon dioxide,
argon,
helium,
hydrogen,
deuterium,
tritium.

According to another particularly advantageous feature of the invention, the second gas is formed by any other gas or mixture of at least two of the gases listed hereinabove. The mixture of oxygen with another gas gives good results in particular in obtaining the fusion reaction.

According to another particularly advantageous feature of the invention, the material of the enclosure is selected from among thermally and/or electrically conductive metals or metal alloys. These choices are made to promote these reactions.

According to another particularly advantageous feature of the invention, an element made of a material different from that of the walls of the enclosure is positioned at the impact area. This feature allows better managing the exploitation of the obtained reactions by changing the atoms subjected to the jet and thus for example synthesising different chemical elements.

When the materials of the walls of the enclosure undergoing the impact or of the element positioned at the impact area contain chemical elements heavier than iron, nuclear fission reactions of these heavy elements occur.

According to another particularly advantageous feature of the invention, the content of the enclosure undergoes a heating before introducing the second gas or gaseous mixture.

According to a preferred embodiment, this heating is implemented by at least one following method:
from the inside,
from the outside,

By any heating means including electrical means.

According to another particularly advantageous feature of the invention, the electricity for the electrical heating originates from solar panels and/or wind turbines.

According to another particularly advantageous feature of the invention, the first hot gas or gaseous mixture results from a combustion carried out in the enclosure.

According to another particularly advantageous feature of the invention, the enclosure is fed with one or more liquid or gaseous fuel(s).

According to another particularly advantageous feature of the invention, when a combustion is implemented in the enclosure, the jet of second gas or gaseous mixture is brought into contact with the combustion flame are used. The sudden change in temperature is then optimised.

According to another particularly advantageous feature of the invention,
the enclosure is equipped with at least one discharge duct.

This duct enables the discharge, where appropriate and when desired, of the combustion gases, plasma, etc. . . . .

According to another particularly advantageous feature of the invention, one or more fresh or hot air jet(s) is/are complementarily arranged in the discharge duct for the purpose of feeding another enclosure.

According to another particularly advantageous feature of the invention, the combustion flame is replaced by a hot gas with a temperature higher than 700° C. (for example and without limitation: hot air, hot CO2, hot N2, hot air-oxygen mixture or any other gas or mixture of gases).

According to another particularly advantageous feature of the invention, the temperature of the second gas (gas forming the jet(s)) is lower than the temperature of the combustion flame of the liquid or gaseous fuels in combustion in the semi-open enclosure.

According to another particularly advantageous feature of the invention, the used fuels are fossil or non-fossil fuels, carbonaceous or not, biofuels, in liquid or gaseous or cryogenic or solid form, for example (without limitation):
Petrol,
Kerosene,
Natural gas,
Propane,
Butane,
Methanol,
Ethanol,
Propanol,
Butanol,
Gasoil,
Hydrogen
Helium,
Deuterium,
Tritium
Mining coal (black coal, peat, anthracite)
Charcoal;

According to another particularly advantageous feature, the wall on which the impact took place consists of a powder or particles or microparticles of metals or alloys of conductive metals. This structure of the material promotes the desired reactions.

The invention also relates to the device allowing implementing all or part of the above-described method.

According to the invention, the device comprises an enclosure comprising a wall equipped with inlet orifices with,
At least one inlet orifice for a first hot gas or gaseous mixture or for a fuel the combustion of which produces a first hot gas or gaseous mixture,
at least one projection nozzle in the form of a jet of a second gas or gaseous mixture under pressure and whose temperature is lower than that of the first gas or gaseous mixture,
said nozzle being directed towards the internal surface of one of the walls forming the enclosure so that the jet of second gas or gaseous mixture hits the wall.

According to another particularly advantageous feature of the invention, the enclosure comprises at least one inlet orifice for a combustible liquid or solid or gas or for a gas resulting from the combustion of fossil or non-fossil fuels;

According to another particularly advantageous feature of the invention, the enclosure comprises at least one ionised gas or plasma outlet orifice and the combustion gases, when a combustion is carried out.

According to another particularly advantageous feature of the invention, the wall or the element undergoing the impact of the jet is inclined with respect to the axis of the jet.

According to another particularly advantageous feature of the invention, the axis of the jet of the second gas or gaseous mixture is inclined by a given angle with respect to the axis perpendicular to the surface of the impact area of the jet. This inclination contributes to the creation of the desired swirl.

According to another particularly advantageous feature of the invention, the thickness of the metal enclosure is comprised between 0.1 mm to 1,000 mm or smaller than 0.1 mm. The thickness contributes to the reaction by activating the migration of the atoms. A small thickness is preferred to promote the tunnel effect.

The method and the device of the invention may be used for the production of energy, for the propulsion of spacecrafts, for the propulsion of aerial and maritime vehicles, for the propulsion of civil aircrafts.

According to another particularly advantageous feature of the invention, the material of the wall of the enclosure is selected from the following list:
304 stainless steel,
316 stainless steel,
iron or iron alloy,
nickel or nickel alloy,
chromium or chromium alloy,
bismuth or bismuth alloy,
lead or lead alloy
aluminium or aluminium alloy.

According to another particularly advantageous feature of the invention, the aluminium or the aluminium alloy is coated over its internal and/or external face with a polytetrafluoroethylene (PTFE) coating.

According to another particularly advantageous feature of the invention, a lead-bismuth plate is arranged in the impact area of the gas jet so as to form iridium and rhodium. Indeed, the particular conditions suggested by the operation of the method enable the synthesis of some metals.

The fundamental concepts of the invention have just been disclosed hereinabove in their most elementary form. Other details and features will appear more clearly upon reading the following description and with reference to the appended figures, giving as non-limiting examples, embodiments of a device in accordance with the invention the results of which are provided and analysed. These results constitute proofs of the reactions obtained by the described and claimed method. Indeed, it appears in the data provided hereinafter that in addition to the excess heat observed, chemical elements already present are produced and new elements appear.

It should be noted that videos of said embodiments have also been made.

### BRIEF DESCRIPTION OF THE FIGURES

FIG. 1 is a schematic drawing of a sectional view of an embodiment of a device in accordance with the invention;

FIG. 2 is a schematic drawing of a sectional view of another embodiment of a device in accordance with the invention;

FIG. 3 is a schematic drawing of a sectional view of another embodiment of a device in accordance with the invention;

FIG. 4 is a schematic drawing of a sectional view of another embodiment of a device in accordance with the invention;

FIG. 5 is a schematic drawing of a sectional view of another embodiment of a device in accordance with the invention;

FIG. 6 is a schematic drawing of a sectional view of another embodiment of a device in accordance with the invention;

FIG. 7 is a schematic drawing of a sectional view of another embodiment of a device in accordance with the invention;

FIG. 8 is a schematic drawing of a sectional view of one embodiment of a fuel supply module feeding the device of the invention;

FIG. 9 is a schematic drawing of a sectional view of another embodiment of a fuel supply module feeding the device of the invention;

FIG. 10 is a photograph of the upper portion of the enclosure of one embodiment of a device in accordance with the invention at stop;

FIG. 11 is a photograph of the upper portion of the enclosure of one embodiment of a device in accordance with the invention in operation;

FIG. 12 is an explanatory schematic drawing of the ionisation of the gases by the method of the invention;

FIG. 13 is a series of photographs relating those of the visual radiation of several embodiments of the invention and those of a black hole;

FIG. 14 is a photograph of the enclosure of one embodiment which has been pierced following fusion thereof;

FIG. 15 consists of two photographs of the front and rear faces of the same embodiment;

FIG. 16 is a photograph of the powder or ash recovered in the enclosure after operation and subjected to analysis;

FIG. 17 is a photograph of the upper portion of the enclosure of the area opposite the impact point and where powder or ash has appeared;

FIG. 18 is a photograph of a portion of the enclosure removed from the latter after operation for analysis purposes;

FIG. 19 is a photograph of a plate used to detect and analyse the particles emitted by the device during operation thereof.

FIG. 20 is a photograph of an impact hole on the plate of FIG. 19 observed using a microscope;

FIG. 21 consists of three photographs illustrating an embodiment of the device where iridium and rhodium are synthesised.

### DETAILED DESCRIPTION

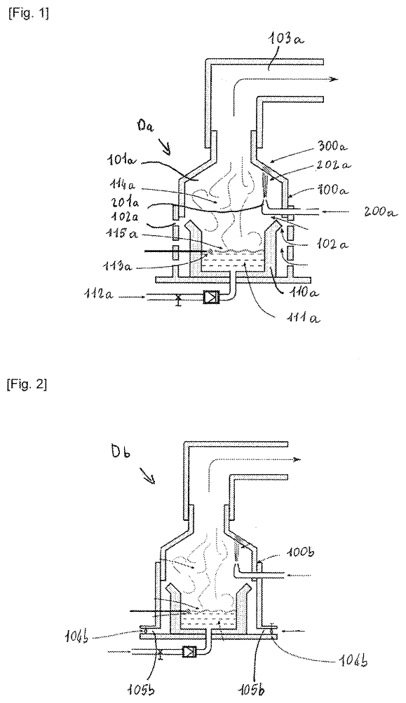

As illustrated in FIG. 1, the device bearing the reference Da as a whole comprises an enclosure 100a defining, thanks to its metal walls, an internal volume 101a in which there is a container 110a of liquid fuel 111a. This liquid fuel is supplied by a supply duct 112a. The container 110a is open on its upper portion and is equipped with an electric igniter 113a. The combustion of the fuel creates flames and gases 114a in the internal volume 101a of the enclosure 100a which then becomes a combustion chamber or a reactor. A gaseous phase 115a of the fuel is present between the upper surface of the liquid and the flames.

The walls of the enclosure 100a are apertured at the lower portion with lateral inlet orifices 102a. These inlet orifices 102a enable air at atmospheric pressure or under low or very low pressure to feed the internal volume with fresh air. The upper portion of the enclosure 100a is provided with a vertical conduit 103a for the discharge to the outside of the combustion gases and/or plasma created by the ionisation of the gases projected before and after percussion produced in the internal volume 101a.

In accordance with the invention, the device Da further comprises a gas supply duct 200a. According to one embodiment, this gas is air compressed between 0.5 and 700 bars by a non-illustrated compressed air supply module. The duct 200a has an inner end equipped with an air projection nozzle 201a and which is positioned in the internal volume 101a of the enclosure 100a. This nozzle 201a projects into the hot gaseous medium composed by the flames and combustion gases 114a a compressed air jet 202a at high speed. This speed is between 30 and 5,000 m/s. The change in temperature contributes to the acceleration of the projected gas jet.

This nozzle 201a is directed towards the lower surface of a wall of the enclosure 100a where a collision occurs. In the impact area 300a of the air jet, fusion occurs where a plasma is created. This impact area is the creation area of the black hole. The inclination of the wall surface where the impact area is located contributes to the desired creation of the ionised hot gas.

According to a preferred yet non-limiting embodiment, the enclosure 100a is made of stainless steel (grade 304 and/or 316), the container 110a of the liquid fuel is made of aluminium or aluminium alloy coated with PTFE or not.

Compressed air can be replaced by:
carbon dioxide,
carbon dioxide associated with oxygen.

The observed phenomena and the obtained results during different tests will be described more specifically later on.

As illustrated in FIG. 2, the device Db differs from Da illustrated in FIG. 1 only in that the supply with fresh air (atmospheric air or under low or very low pressure) is implemented by two valves 104b for shutting off and regulating the air flow rate controlling two ducts 105b. Hence, the enclosure 100b is not provided with air inlet orifices but with two ducts 105b controlled by the valves 104b. The black hole is created at the same location. According to a preferred embodiment, the materials are also the same.

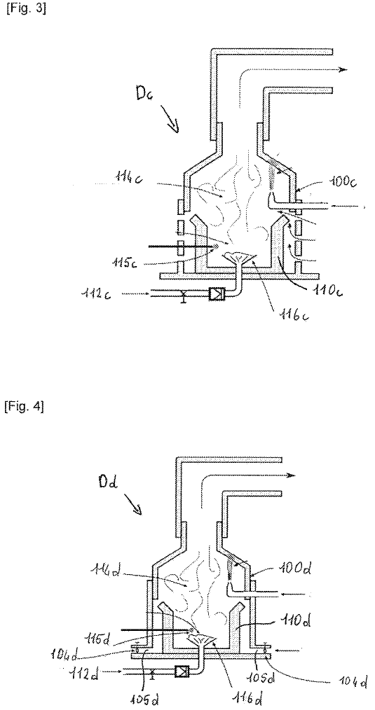

As illustrated in FIG. 3, the device Dc differs from Da illustrated in FIG. 1 only in that the fuel is gaseous. Consequently, the duct 112c conveys into the container 110c a combustible gas and opens into the latter by means of a burner 116c which, in association with the igniter 115c, ensures the combustion of the gas and the creation of the hot gaseous mixture 114c in the internal volume of the enclosure 100c. The black hole is created at the same location. According to a preferred embodiment, the materials are also the same.

As illustrated in FIG. 4, the device Dd associates the embodiment Db of FIG. 2 with that Dc of FIG. 3 in that the fuel is gaseous and that the fresh air supply (atmospheric air or under low or very low pressure) is implemented by two valves 104d for shutting off and regulating the air flow rate controlling two ducts 105d. Hence, the enclosure 100d is not provided with air inlet orifices but with two ducts 105d controlled by the valves 104d.

In addition, the duct 112d conveys into the container 110d a combustible gas and opens into the latter by means of a burner 116d which, in association with the igniter 115d, ensures the combustion of the gas and the creation of the hot gaseous mixture 114d in the internal volume of the enclosure 100d. The black hole is created at the same location. According to a preferred embodiment, the materials are also the same.

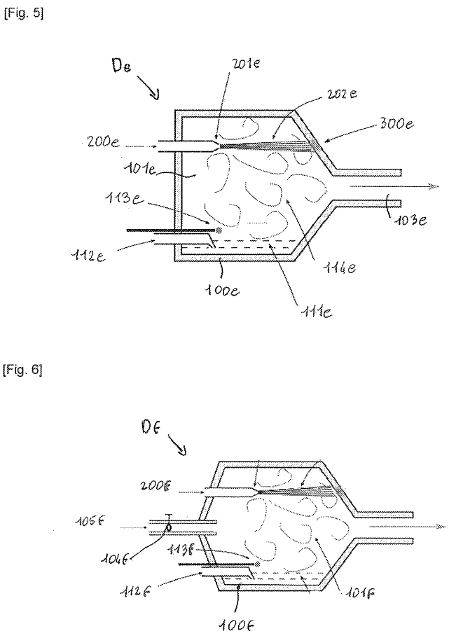

As illustrated in FIG. 5, the device De replicates the principles of the device Da of FIG. 1 with a simpler and more closed design.

Thus, the device De comprises an enclosure 100e defining, thanks to its metal walls, an internal volume 101e in which a liquid fuel 111e is present in the lower portion. This liquid fuel is supplied through a supply duct 112e. The enclosure 100e is equipped with an electric igniter 113e. The combustion of the fuel creates flames and gases 114e in the internal volume 101e of the enclosure 100e.

A lateral wall of the enclosure 100a is provided with a horizontal duct 103e for the discharge to the outside of the combustion gases and/or plasma (created by the ionisation of the gases before and after percussion of the wall) produced in the internal volume 101e.

The device De further comprises a compressed air supply duct 200e. This air is compressed between 0.5 and 700 bars by a non-illustrated compressed air supply module. The duct 200e has an inner end equipped with an air projection nozzle 201e and which is positioned in the internal volume 101e of the enclosure 100e. This nozzle 201e projects into the hot gaseous medium composed by the flames and combustion gases 114e a compressed air jet 202e at high speed. This speed is between 30 and 5,000 m/s.

This nozzle 201e is directed towards the internal surface of a wall of the enclosure 100e. The impact area 300e of the air jet on the wall is in the axis of the duct 200e and is the creation area of the black hole.

As illustrated, the ducts 200e, 112e and the electric igniter 113e open out at a lateral wall of the enclosure 100e arranged in opposition to the lateral wall of the enclosure provided with the horizontal duct 103e.

The suggested design is closed in that the inlet air comes exclusively from the duct 200e which conveys the compressed air. Furthermore, it is simpler in that the fuel 111e does not have a dedicated container but is stored directly in a volume defined by the lower walls of the enclosure 100e.

As illustrated in FIG. 6, the device Df differs from De illustrated in FIG. 5 only in that the supply of fresh air (atmospheric air or under low or very low pressure) is implemented by a valve 104f for shutting off and regulating the air flow rate controlling one duct 105f. This duct opens into the internal volume 101f throughout the same lateral wall of the enclosure 100f as that crossed by the compressed air supply 200f ducts, the fuel supply 112f ducts and by the electric igniter 113f. The black hole is created at the same location. According to a preferred embodiment, the materials are also the same.

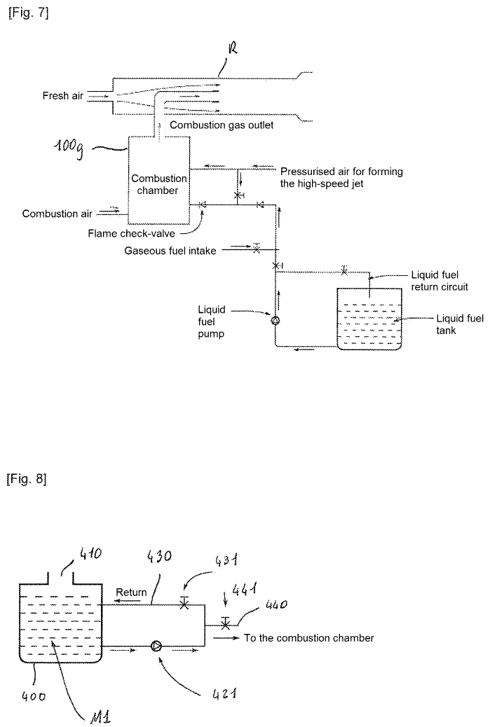

FIG. 7 shows a combustion chamber 100g from which the hot gases generated by the reactions come out and contribute to the operation of a reactor R such as that of an aircraft.

These hot gases may also contribute to heating of a first gas or gaseous mixture in another enclosure (not illustrated).

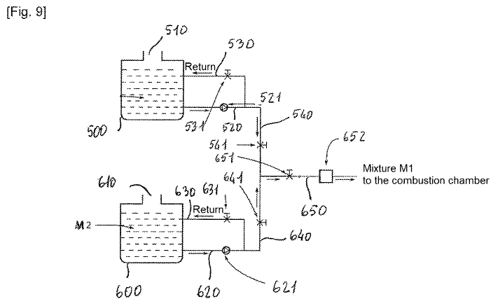

As illustrated in FIG. 8, the liquid fuel supply module bearing the reference M1 is remarkable in that it ensures the preparation of the mixture M1 upstream of the enclosure of one of the above-described liquid fuel devices.

This supply module comprises a tank 400 storing the mixture M1. Said reservoir 400 comprises an opening 410 at the upper portion and is equipped with:
a liquid outlet duct 420 at the lower portion,
a return duct 430 at the upper portion.

These two ducts join into a common duct 440 which links with the enclosure of one of the above-described liquid fuel devices.

The outlet duct 420 is associated with an adjustable variable flow pump 421. Each of the return duct 430 and the common duct 440 is equipped with a regulating and shut-off valve 431 and 441.

The return duct 430 enables the return to the reservoir 400.

According to a preferred embodiment, the composition of the mixture M1 is as follows:
Ethanol with a concentration comprised between 40% and 70%,
Water with a concentration comprised between 15% and 30%,
Hydrogen peroxide with a concentration comprised between 15% and 30%,
Phosphoric acid with a concentration comprised between 0.03% and 0.06%,
Silver with a concentration comprised between 0.0015% and 0.003%.

According to other embodiments, the ethanol is replaced by methanol, propanol, butanol or by another fuel.

FIG. 9 illustrates another liquid fuel supply module bearing the reference M1.

This module comprises two equivalent tanks 500 and 600 equipped in the same way as the above-described tank 400 and whose common ducts 540 and 640 join into a unique duct 650 to form the mixture M1 before feeding the enclosure of one of the above-described liquid fuel devices.

Thus, the tank 500 stores ethanol (with a concentration higher than 96%) and comprises an opening 510 at the upper portion and is equipped with:
a liquid outlet duct 520 at the lower portion,
a return duct 530 at the upper portion.

These two ducts join into a common duct 540.

The outlet duct 520 is associated with an adjustable variable flow pump 521. Each of the return duct 530 and the common duct 540 is equipped with a regulating and shut-off valve 531 and 541.

The tank 600 stores a mixture M2 and comprises an opening 610 at the upper portion and is equipped with:
a liquid outlet duct 620 at the lower portion,
a return duct 630 at the upper portion.

These two ducts join into a common duct 640.

The outlet duct 620 is associated with an adjustable variable flow pump 621. Each of the return duct 630 and the common duct 640 is equipped with a regulating and shut-off valve 631 and 641.

According to a preferred embodiment, the composition of the mixture M2 is as follows:
Water with a concentration comprised between 35% and 70%,
Hydrogen peroxide with a concentration comprised between 35% and 70%,
Phosphoric acid with a concentration lower than or equal to 0.1%,
Silver with a concentration lower than or equal to 0.005%.

The obtained ignition temperature of M1 is higher than the ignition temperature of ethanol (96%) alone which is higher than 40-50° Celsius.

Management of the supply of a device as described hereinabove implemented in the form of an aircraft reactor may be as follows:
take-off phase: use of ethanol alone,
cruise phase: use of the mixture M1,
Landing phase: use of ethanol alone or of the mixture M1.

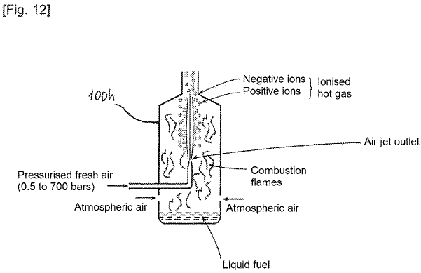

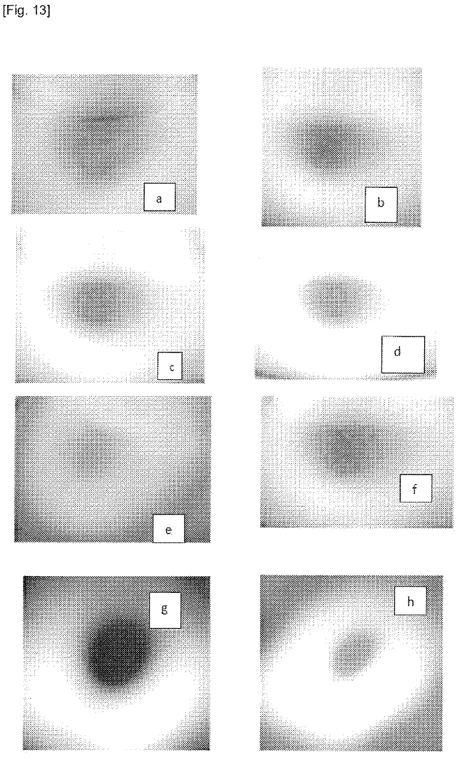

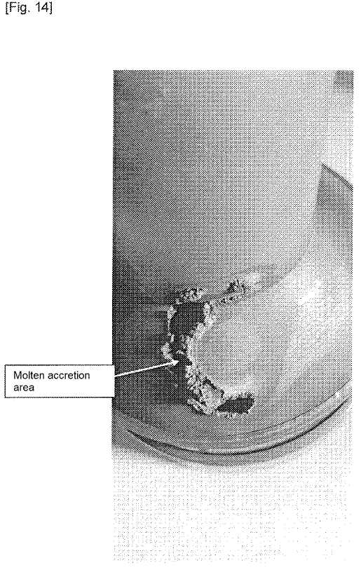

FIG. 12 illustrates an embodiment of an enclosure where the ionisation of the gases and therefore the creation of a plasma is illustrated. In accordance with the invention, the pressurised jet outlet of the gas is accelerated in particular by the change in temperature due to contact between the gas at the nozzle outlet and the combustion flames. It is this gas jet which will form a plasma which will hit the internal surface of a wall of the enclosure 100h.

The fresh air composing the second gas is under pressure between 0.5 and 700 bars. The air jet outlet is higher than 10 m/s or higher than 20 m/s or higher than 30 m/s or higher than 50 m/s. The speed may range up to 5,000 m/s.

The Applicants have taken photographs
during the first tests on a prototype in accordance with the features of the devices Da or Db where
the enclosure is made of 316 stainless steel,
the container is made of aluminium or aluminium alloy coated with PTFE,
the used fuel is 96% ethanol, and where
the gas used for the jet is a mixture of carbon dioxide and oxygen.

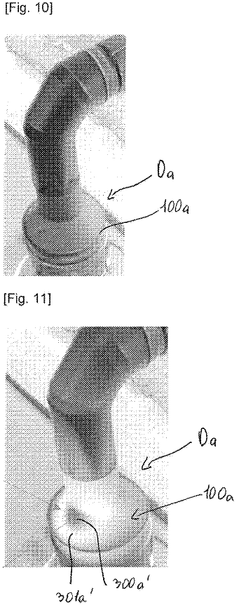

These photographs are reproduced in black and white in FIGS. 10 and 11

Photograph 10 illustrates during a phase of stopping the top of the device, for example Da, where the enclosure 100a keeps the colour of its material.

Photograph 11 illustrates during operation the change in colour of the enclosure or reactor visible from the outside. Under the action of the heat, the enclosure 100a reddens until whitening. In addition, at the impact point where the black hole is formed, a darker area 300a′ appears at the external surface.

As illustrated, the darker zone 300a′ and the light halo 301a′ surrounding it reproduce the distinctive elements of a black hole, namely its centre and its accretion disc.

Photographs a, b, c, d, e, f, g, h of FIG. 13 show the resemblance between what happens in the device and the known photographs of black holes.

The first 6 photographs (a to f) are real photos of the black holes created during the operation of the device. These are real images and not rendered images. The black hole in (a) is obtained with CO2 alone as jet gas. The black hole at b is obtained with air as jet gas. The black holes in C, d, e and f are obtained with a CO2+O2 mixture as jet gas. The last two images (g and h) are images of the M87 black hole located in the M87 galaxy and filmed in 2019 by the EHT (Event Horizon Telescope) telescope.

The Applicants have noticed that an excessive heating in the accretion area resulted in a melt-down of the enclosure at said accretion area. This melt-down occurs at the accretion disc and is illustrated by the photograph of FIG. 1 where the molten accretion area appears clearly.

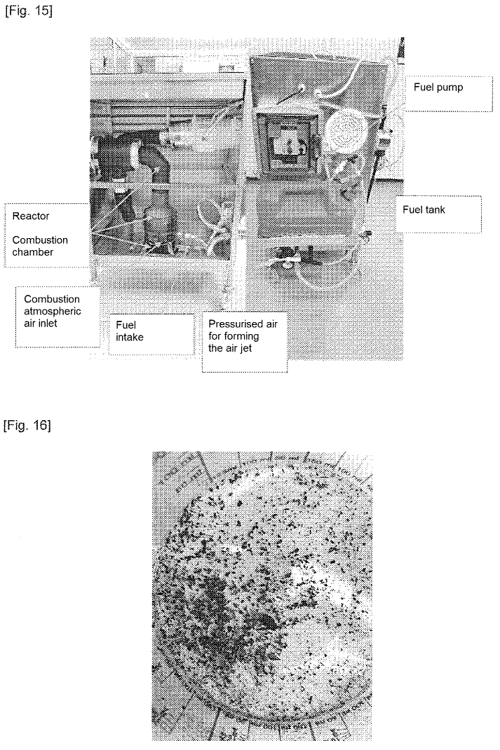

In addition, they have carried out a plurality of readings enabling a better understanding of the different contributions of the invention, in particular on the plant illustrated by the photographs of FIG. 15.

The composition of the combustion gases and/or of the plasma at the outlet the enclosure or reactor is as follows:

TABLE 1

| | | | | | | | | |
|---|---|---|---|---|---|---|---|---|
| CO2 (%) V/V | 12.9 | 12 | 10.8 | 9.5 | 9.2 | 9.0 | | |
| CO (%) V/V | 2.58 | 4.83 | 6.36 | 8.17 | 8.62 | 9.0 | | |
| O2 (%) V/V | 0.1 | 0.06 | 0.0 | 0.00 | 0.00 | 0.00 | | |
| HC (ppm) | 175 | 199 | 247 | 285 | 325 | 347 | | |
| NO (ppm) | 0 | 0 | 0 | 0 | 0 | 0 | | |
| AFR (air fuel | 13.58 | 12.70 | 12.04 | 11.33 | 11.13 | 11 | | |
| ratio) | | | | | | | | |
| Temperature | 928.7 | 937.2 | 942.8 | 926.6 | 926.8 | 929.5 | | |
| (° C.) with | | | | | | | | |
| cooling of the | | | | | | | | |
| external walls | | | | | | | | |
| of the tube at | | | | | | | | |
| the reactor | | | | | | | | |
| outlet | | | | | | | | |
| Average | 1180 | 1180 | 1180 | 1180 | 1180 | 1180 | 1180 | 1180 |
| temperature | | | | | | | | |
| (° C.) without | | | | | | | | |
| cooling of the | | | | | | | | |
| external walls | | | | | | | | |
| of the tube at | | | | | | | | |
| the reactor | | | | | | | | |
| outlet | | | | | | | | |

This table shows the obtained upper temperature. The Applicants estimate that 1,500° Celsius are possible at the output. Nevertheless, a temperature substantially higher than 300° Celsius is estimated inside the enclosure.

The electrical resistance of the gases at the outlet of the device has also been measured. The measured resistance ranges from 10 to 500 KOhm, which proves the presence and therefore the formation of plasma. Hence, the electrical resistance of hot air measured at the same temperature without reaction as defined in the invention is infinite under these conditions.

The Applicants have carried out a plurality of analyses in order to determine the emitted elements or products and those destroyed during operation of the device.

Several analysis means have been implemented, including an X-ray fluorescence spectrometer which has been used to analyse several areas of the walls of the enclosure.

Before operation of the device, the analyses carried out on 5 different areas identified from 29 to 33 have given the following results:

TABLE 2

| | MEASURE- | | MEASURE- | | MEASURE- | | MEASURE- | | MEASURE- |
|---|---|---|---|---|---|---|---|---|---|
| [symbol] | MENT | [symbol] | MENT | [symbol] | MENT | [symbol] | MENT | [symbol] | MENT |
| Elements | C [symbol] | [symbol] | C [symbol] | [symbol] | Co [symbol] | [symbol] | Co [symbol] | [symbol] | Co [symbol] |
| Fe | [symbol] % | Fe | [symbol] 8 [symbol] | Fe | [symbol] | Fe | [symbol] | Fe | [symbol] |
| [symbol] | [symbol] 8% | [symbol] | [symbol] .72% | C [symbol] | [symbol] | C [symbol] | 1 [symbol] . [symbol] % | C [symbol] | [symbol] |
| [symbol] | 10. [symbol] % | [symbol] | 10.13% | [symbol] | 8. [symbol] 4% | [symbol] | [symbol] .35% | [symbol] | [symbol] % |
| M [symbol] | 0. [symbol] % | M [symbol] | [symbol] % | [symbol] | 1. [symbol] % | M [symbol] | 1.0 [symbol] % | M [symbol] | [symbol] |
| [symbol] | [symbol] | M [symbol] | [symbol] % | M [symbol] | [symbol] % | M [symbol] | [symbol] . [symbol] % | M [symbol] | 0. [symbol] |
| C [symbol] | 0. [symbol] % | C [symbol] | 0.29% | [symbol] | 0. [symbol] % | [symbol] | 0.30% | C [symbol] | [symbol] |
| [symbol] | 0. [symbol] % | [symbol] | 0.2 [symbol] % | [symbol] | 0. [symbol] % | S [symbol] | 0. [symbol] 0% | [symbol] | [symbol] |
| Al | | [symbol] | | [symbol] | | [symbol] | | [symbol] | |
| W | 0.10% | W | 0.07% | W | 0.07% | W | | W | |

| | | | | |
|---|---|---|---|---|
| Reference 29 | Reference 30 | Reference 31 | Reference 32 | Reference 33 |

[symbol]

indicates data missing or illegible when filed

After operation, the Applicants have noticed the creation of a reaction powder or ash inside and outside the enclosure.

The powder or ash recovered inside the enclosure is illustrated by the photograph in FIG. 16

The ash formed inside the enclosure resulting from contact between the plasma and the upper walls of the enclosure has the following composition:

TABLE 3

| POWDER | MEASUREMENT |
|---|---|
| Elements | Concentration |
| Fe | 89.86% |
| Cr | 0.43% |
| Ni | 1.68% |
| Mn | 1.34% |
| Sn | 0.46% |
| Cu | 0.28% |
| Sl | 0.10% |
| Mg | 4.05% |
| Zn | 0.37% |
| Ti | 0.13% |
| Al | 1.09% |
| Sb | 0.22% |

This ash has been obtained in the chamber with ethanol as fuel (97% at 6 kg/h) and a jet of compound gas (120 l/min air combined with 80 l/min oxygen).

After operation of the device, the analyses of the ash present at the external surface of the enclosure in the accretion area as it appears in the photograph in FIG. 17 (at the upper portion) have given the following results:

TABLE 4

| POWDER | MEASUREMENT |
|---|---|
| Elements | Concentration |
| Fe | 92.41% |
| Cr | 1.51% |
| Ni | 3.84% |
| Mn | 1.41% |
| Cu | 0.32% |
| Co | 0.24% |
| Mo | 0.06% |
| Al | 0.06% |
| P | 0.05% |

This ash has been obtained at the external surface of the enclosure with ethanol as fuel (97% at 6 kg/h) and a jet of compound gas (air 80 l/min combined with oxygen 20 l/min).

The analysis of these internal and external ashes allows noticing that:

the proportion of some chemical elements (substances) already present before operation changes (the proportion of Iron increases), and bodies of chemical elements (substances) that were not present (such as aluminium, cobalt, magnesium) before operation have appeared.

This demonstrates the presence of nuclear fusion and transmutation reaction corresponding to the reactions that might be found in a black hole. There is fusion because one could notice the chromium atoms being transformed into iron atoms by atomic weight increase and transmutation because one could notice the nickel atoms being transformed into iron atoms by atomic weight decrease.

An analysis of other areas of the enclosure and those already identified has been carried out and gives the following results:

TABLE 5

| | MEASURE- | | MEASURE- | | MEASURE- | | MEASURE- | | MEASURE- | | MEASURE- |
|---|---|---|---|---|---|---|---|---|---|---|---|
| No. 1 | MENT | No. 2 | MENT | No. 3 | MENT | No. 4 | MENT | No. 5 | MENT | No. 6 | MENT |
| Ele- | Concen- | Ele- | Concen- | Ele- | Concen- | Ele- | Concen- | Ele- | Concen- | Ele- | Concen- |
| ments | tration | ments | tration | ments | tration | ments | tration | ments | tration | ments | tration |
| Fe | 53.7 [symbol] % | Fe | [symbol] % | Fe | [symbol] | Fe | [symbol] % | Fe | [symbol] | Fe | [symbol] 1.04% |
| C [symbol] | 2 [symbol] . [symbol] % | [symbol] | [symbol] % | Cr | [symbol] | [symbol] | [symbol] | [symbol] | [symbol] | Cr | 2.97% |
| [symbol] | 34. [symbol] % | [symbol] | [symbol] % | [symbol] | [symbol] .21% | [symbol] | [symbol] % | [symbol] | 8. [symbol] | [symbol] | 2.4 [symbol] % |
| M [symbol] | 0. [symbol] % | M [symbol] | [symbol] % | M [symbol] | 1.1 [symbol] % | M [symbol] | [symbol] .20% | M [symbol] | 1. [symbol] | Mn | 1. [symbol] |
| M [symbol] | [symbol] | M [symbol] | [symbol] % | M [symbol] | 2. [symbol] % | M [symbol] | [symbol] | M [symbol] | [symbol] | M [symbol] | 1. [symbol] % |
| [symbol] | 0. [symbol] | [symbol] | 0. [symbol] % | [symbol] | [symbol] | [symbol] | [symbol] % | [symbol] | [symbol] | C [symbol] | 0.31% |
| [symbol] | 0. [symbol] % | [symbol] | [symbol] % | [symbol] | [symbol] | [symbol] | [symbol] | [symbol] | [symbol] | | |
| Al | 0. [symbol] % | [symbol] | 0.1 [symbol] % | [symbol] | [symbol] % | [symbol] | [symbol] | [symbol] | [symbol] | | |
| W | 0.0 [symbol] | W | [symbol] | W | [symbol] | W | [symbol] | W | [symbol] | | |
| | | | | | | | | [symbol] | [symbol] | | |

| | MEASURE- | | MEASURE- | | | | MEASURE- | | | | MEASURE- |
|---|---|---|---|---|---|---|---|---|---|---|---|
| No. 7 | MENT | | MENT | | MEASURE- | | MENT | | MEASURE- | No. 12 | MENT |
| Ele- | Concen- | No. 8 | Concen- | No. 9 | MENT | No. 10 | Concen- | No. 11 | MENT | Ele- | Concen- |
| ments | tration | [symbol] | tration | [symbol] | C [symbol] | [symbol] | tration | [symbol] | [symbol] | ments | tration |
| Fe | 24. [symbol] % | Fe | [symbol] | [symbol] | [symbol] | Fe | [symbol] | Fe | [symbol] % | [symbol] | [symbol] |
| C [symbol] | 1 [symbol] | C [symbol] | [symbol] | [symbol] | [symbol] | C [symbol] | [symbol] | C [symbol] | [symbol] % | C [symbol] | [symbol] |
| N [symbol] | [symbol] .07% | N [symbol] | [symbol] % | [symbol] | [symbol] | [symbol] | [symbol] | [symbol] | [symbol] % | [symbol] | [symbol] |
| M [symbol] | 1.2 [symbol] | M [symbol] | 1 [symbol] | M [symbol] | [symbol] | M [symbol] | [symbol] | M [symbol] | [symbol] | M [symbol] | [symbol] |
| M [symbol] | [symbol] | M [symbol] | 2 [symbol] | M [symbol] | 2.3 [symbol] | M [symbol] | [symbol] | M [symbol] | [symbol] | M [symbol] | [symbol] |
| C [symbol] | [symbol] | C [symbol] | [symbol] | C [symbol] | 0. [symbol] | C [symbol] | [symbol] | C [symbol] | [symbol] | [symbol] | [symbol] |
| [symbol] | 0. [symbol] | [symbol] | 0. [symbol] | [symbol] | [symbol] | [symbol] | 0. [symbol] | [symbol] | [symbol] | [symbol] | [symbol] |
| Al | 0. [symbol] % | Al | 0. [symbol] | Al | 0.13 [symbol] | [symbol] | [symbol] | [symbol] | [symbol] | [symbol] | [symbol] |
| W | 0. [symbol] | W | 0. [symbol] | W | [symbol] | W | 0. [symbol] | W | [symbol] | W | [symbol] |
| | | [symbol] | 0. [symbol] % | [symbol] | [symbol] | [symbol] | 0. [symbol] | | | | |

| | MEASURE- | | MEASURE- | | MEASURE- | | MEASURE- | | |
|---|---|---|---|---|---|---|---|---|---|
| No. 13 | MENT | No. 14 | MENT | No. 15 | MENT | No. 16 | MENT | No. 17 | MEASURE- |
| Ele- | Concen- | Ele- | Concen- | Ele- | Concen- | Ele- | Concen- | Ele- | MENT |
| ments | tration | ments | tration | ments | tration | ments | tration | ments | [symbol] |
| Fe | [symbol] | Fe | 72. [symbol] | Fe | [symbol] 0.41% | Fe | [symbol] | Fe | 73.42% |
| C [symbol] | 1 [symbol] .5 [symbol] | C [symbol] | [symbol] | C [symbol] | [symbol] | C [symbol] | [symbol] | C [symbol] | 1 [symbol] . [symbol] % |
| [symbol] | 1 [symbol] % | [symbol] | [symbol] | [symbol] | [symbol] | [symbol] | [symbol] | [symbol] | [symbol] % |
| M [symbol] | 1.01% | M [symbol] | [symbol] | M [symbol] | 1. [symbol] | M [symbol] | [symbol] .13% | M [symbol] | [symbol] |
| M [symbol] | [symbol] | M [symbol] | [symbol] | M [symbol] | [symbol] | M [symbol] | [symbol] .0 [symbol] % | M [symbol] | 0. [symbol] |
| C [symbol] | 0. [symbol] | C [symbol] | [symbol] | C [symbol] | 0. [symbol] | C [symbol] | 0. [symbol] | C [symbol] | 0. [symbol] |
| [symbol] | 0. [symbol] | [symbol] | [symbol] | [symbol] | 0.51% | [symbol] | [symbol] % | [symbol] | 0. [symbol] |
| Al | 0. [symbol] | Al | [symbol] | W | 0.09% | W | 0.0 [symbol] | W | 0. [symbol] |
| | | W | [symbol] | | | | | | |

[symbol]

indicates data missing or illegible when filed

TABLE 6

| No. 21 | MEASURE- | | MEASURE- | | MEASURE- | | MEASURE- | No. 25 | MEASURE- | No. 26 | MEASURE- |
|---|---|---|---|---|---|---|---|---|---|---|---|
| Ele- | MENT | No. 22 | MENT | No. 23 | MENT | No. 24 | MENT | Ele- | MENT | Ele- | MENT |
| ments | C [symbol] | [symbol] | C [symbol] | [symbol] | [symbol] | [symbol] | Con [symbol] | ments | [symbol] | ments | C [symbol] |
| Fe | [symbol] % | Fe | [symbol] | Fe | [symbol] .72% | Fe | [symbol] | [symbol] | [symbol] | [symbol] | [symbol] |
| C [symbol] | 1 [symbol] [symbol] | C [symbol] | 27. [symbol] | C [symbol] | 21. [symbol] % | C [symbol] | [symbol] | C [symbol] | [symbol] | C [symbol] | [symbol] |
| [symbol] | 1 [symbol] . [symbol] | [symbol] | [symbol] .8 [symbol] % | [symbol] | [symbol] 0% | [symbol] | [symbol] | [symbol] | [symbol] | [symbol] | [symbol] % |
| M [symbol] | [symbol] % | M [symbol] | 0.7 [symbol] % | M [symbol] | [symbol] | M [symbol] | 1.0 [symbol] | M [symbol] | [symbol] | M [symbol] | [symbol] |
| M [symbol] | [symbol] | M [symbol] | [symbol] | M [symbol] | [symbol] | M [symbol] | [symbol] | M [symbol] | [symbol] | M [symbol] | 2. [symbol] |
| C [symbol] | 0. [symbol] | C [symbol] | 0. [symbol] | C [symbol] | 0. [symbol] | C [symbol] | [symbol] | C [symbol] | 0. [symbol] | C [symbol] | 0. [symbol] |
| [symbol] | 0. [symbol] | [symbol] | 0. [symbol] | [symbol] | 0. [symbol] | [symbol] | 0. [symbol] | [symbol] | [symbol] | [symbol] | 0. [symbol] |
| W | 0. [symbol] | [symbol] | 0. [symbol] | [symbol] | 0. [symbol] | [symbol] | 0. [symbol] | [symbol] | 0.0 [symbol] | [symbol] | 0.0 [symbol] |
| | | W | 0. [symbol] | [symbol] | 0. [symbol] | | | | | | |
| | | | | [symbol] | 0.0 [symbol] | | | | | | |

| | MEASURE- | | MEASURE- | | MEASURE- | | MEASURE- | | MEASURE- |
|---|---|---|---|---|---|---|---|---|---|
| No. 27 | MENT | No. 28 | MENT | No. 29 | MENT | No. 30 | MENT | No. 31 | MENT |
| Ele- | Concen- | Ele- | Concen- | Ele- | Concen- | Ele- | Concen- | Ele- | Concen- |
| ments | tration | ments | tration | ments | tration | ments | tration | ments | tration |
| Fe | [symbol] .83% | Fe | [symbol] | Fe | [symbol] .54% | Fe | [symbol] | Fe | [symbol] 1. [symbol] |
| C [symbol] | 20.3 [symbol] % | Cr | 18.4 [symbol] % | C [symbol] | 17. [symbol] | Cr | 26. [symbol] % | Cr | [symbol] % |
| [symbol] | [symbol] .42% | [symbol] | [symbol] % | Ni | 10.2 [symbol] % | N [symbol] | [symbol] | [symbol] | [symbol] % |
| M [symbol] | [symbol] % | M [symbol] | 0. [symbol] | Mn | 0.8 [symbol] % | Mn | [symbol] .02% | M [symbol] | 1. [symbol] % |
| M [symbol] | 2. [symbol] | M [symbol] | [symbol] | Mo | [symbol] 0.5% | Mo | 2.0 [symbol] % | M [symbol] | 0. [symbol] % |
| C [symbol] | [symbol] .48% | C [symbol] | 0. [symbol] % | C [symbol] | 0.40% | Cu | 0.29% | C [symbol] | 0. [symbol] |
| [symbol] | 0.27% | [symbol] | 0. [symbol] | S [symbol] | 0. [symbol] 0% | S [symbol] | 0.2 [symbol] % | [symbol] | 0. [symbol] |
| | | [symbol] | 0.0 [symbol] | Al | | Al | | Al | |
| | | | | W | 0.10% | W | 0.0 [symbol] % | W | 0.0 [symbol] % |

| | MEASURE- | | |
|---|---|---|---|
| No. 32 | MENT | No. 33 | MEASURE- |
| Ele- | Concen- | Ele- | MENT |
| ments | tration | ments | C [symbol] |
| Fe | [symbol] | [symbol] | [symbol] 3.3 [symbol] % |
| Cr | 16.70% | C [symbol] | [symbol] |
| N [symbol] | 1. [symbol] | [symbol] | [symbol] % |
| M [symbol] | 1. [symbol] | M [symbol] | [symbol] |
| M [symbol] | 2.3 [symbol] | M [symbol] | 0. [symbol] |
| C [symbol] | 0. [symbol] | C [symbol] | 0. [symbol] |
| [symbol] | 0. [symbol] | [symbol] | 0. [symbol] |
| Al | | Al | |
| W | | W | |

[symbol]

indicates data missing or illegible when filed

These results have been obtained with ethanol as fuel at 97% 6 g/h and a gas jet composition with air (80 l/min) oxygen (20 to 40 l/min) and carbon dioxide (0 to 20 l/min).

Herein again, the proportion of some chemical bodies already present before operation changes, and chemical bodies that were not present before operation have appeared.

This demonstrates the presence of nuclear fusion and transmutation reaction corresponding to the reactions that might be found in a black hole.

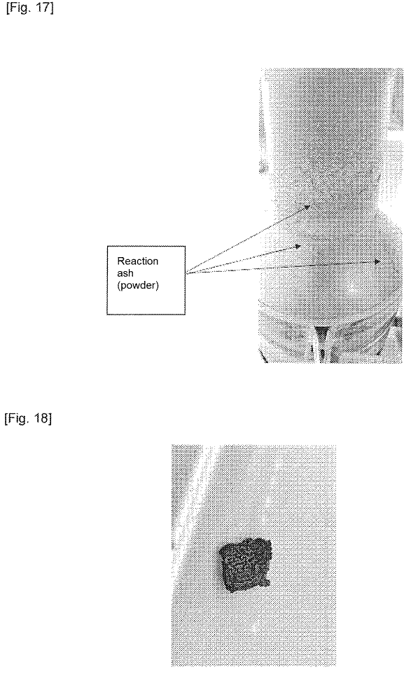

During operation of an embodiment of the device where the wall of the enclosure or reactor has been pierced under the action of fusion, the Applicants have analysed two faces of the residual portion removed from the wall, which portion is illustrated by the photograph of FIG. 18.

The results of these analyses are as follows:

TABLE 7
Reactor external face

| STAINLESS STEEL | MEASUREMENTS |
|---|---|
| Elements | Concentration |
| Fe | 60.72% |
| Cr | 21.16% |
| Ni | 10.79% |
| Mn | 1.24% |
| Mo | 2.39% |
| Cu | 0.29% |
| Sl | 0.21% |

Reactor internal face

| | MEASUREMENT |
|---|---|
| Elements | Concentration |
| Fe | 63.23% |
| Cr | 1 [symbol] .91% |
| Ni | 9.77% |
| Mn | 2.46% |
| Mg | 5.39% |
| Cu | 0.27% |
| Sl | 0.35% |
| Al | 1.80% |
| Sb | 0.41% |
| Sn | 0.36% |

[symbol]

indicates data missing or illegible when filed

It appears that if the composition on the external face of the enclosure almost looks like that of a 316 grade stainless steel, the composition analysed at the internal surface reveals different proportions and new components, demonstrating the implementation of fusion and transmutation reactions.

These results have been obtained with ethanol as fuel (97% at 6 Kg/h) and with a gas jet composed of air (120 l/min) and oxygen (80 l/min).

These first observations have led to specifying the analyses of the different elements (powder, residual portion originating from the hole) appearing after operation of the device in particular by varying the oxygen flow rate from 20 to 60 l/min.

The different elements analysed have been referenced as follows:
1 powder vial ref. rfdo20p (jet-forming gas: air 85 l/min+O2 20 l/min);
1 powder vial ref. rfdo60p (jet-forming gas: air 85 l/min+O2 60 l/min);
1 piece of metal 1 measure rfd60mf1 cambered face (part originating from the reactor hole+jet-forming gas: air 85 l/min+O2 60 l/min);
1 piece of metal 1 measure hollow face rfd60mf2 (part originating from the reactor hole+jet-forming gas: air 85 l/min+O2 60 l/min);
small piece of metal (part originating from the reactor hole+jet-forming gas: air 85 l/min+O2 60 l/min);
small piece of metal (part originating from the reactor hole+jet-forming gas: air 85 l/min+O2 60 l/min);
1 powder vial ref. rfdo20p (jet-forming gas: air 85 l/min+O2 20 l/min);
1 powder vial ref. rfdo60p (jet-forming gas: air 85 l/min+O2 60 l/min);
1 piece of metal 1 measure rfd60maf1 rough side (part originating from the reactor hole);
1 piece of metal 1 measure rfd60maf2 smooth side (part originating from the reactor hole);
1 piece of metal 1 measure rfd60mbf1 rough side (part originating from the reactor hole);
1 piece of metal 1 measure rfd60mbf2 smooth side (part originating from the reactor hole);
1 piece of metal 1 measure rfd60mc1 rough side (part originating from the reactor hole);
1 piece of metal 1 measure rfd60mc2 smooth side (part originating from the reactor hole);
1 piece of metal 1 measure rfd60md1 rough side (part originating from the reactor hole);
1 piece of metal 1 measure rfd60md2 smooth side (part originating from the reactor hole);
The analyses of these different elements are set out in the following tables:

[Table 8]

As with the previous analyses, these analyses show:
the high concentration of iron in the reaction ashes (powders). This concentration of iron varies from about 70% in the material composing the walls of the enclosure before the reaction to about 92-96% in the ash (reaction powder). Hence, there is an iron production. This produced iron primarily originates from the transformation of nickel and cobalt because at the same time, a decrease in the concentration of chromium and nickel in the reaction ashes (powders) is observed. The concentration of nickel varies from about 10% in the material composing the walls of the enclosure before the reaction to about 0.93-3.84% in the ash (reaction powder). The concentration of chromium varies from about 18% in the material composing the walls of the enclosure before the reaction to about 0.74-1.51% in the reaction ash (powder),
the apparition of new elements such as cobalt (0.19-0.24%), aluminium, titanium, sulphur, phosphorus.

TABLE 9
POWDER REF RFDO60P

| 1.8934 | MEASUREMENT |
|---|---|
| Elements | Concentration |
| Fe | 88.29% |
| Cr | 3.72% |
| Ni | 3.54% |
| Mn | 1.23% |
| Mo | 0.38% |
| Cu | 0.31% |
| Sl | 0.16% |
| Ti | 1.10% |
| Al | 0.10% |
| S | 0.67% |
| V | 0.45% |

TABLE 10
No. RFDO6MF1

| 1.4532 | MEASUREMENT |
|---|---|
| Elements | Concentration |
| Fe | 72.39% |
| Cr | 16.05% |
| Ni | 7.49% |
| Mn | 1.37% |
| Mo | 2.07% |
| Cu | 0.25% |
| S | 0.11% |
| Sl | 0.06% |
| Al | 0.08% |
| W | 0.08% |

TABLE 11
No. RFDO60MF2

| 1.4532 | MEASUREMENT |
|---|---|
| Elements | Concentration |
| Fe | 70.84% |
| Cr | 16.07% |
| Ni | 8.99% |
| Mn | 1.71% |
| Mo | 1.72% |
| Cu | 0.20% |
| Sl | 0.13% |
| Al | 0.10% |
| V | 0.05% |
| W | 0.05% |

TABLE 12
No. SMALL PIECE 1

| 1.4532 | MEASUREMENT |
|---|---|
| Elements | Concentration |
| Fe | 74.16% |
| Cr | 14.16% |
| Ni | 7.70% |
| Mn | 1.57% |
| Mo | 1.49% |
| Cu | 0.22% |
| Sl | 0.13% |
| P | 0.15% |
| Al | 0.07% |
| V | 0.04% |

TABLE 14
POWDER [symbol] REF

[symbol]

| [symbol] | | POWDER REF [symbol] | | [symbol] | | [symbol] | | [symbol] | |
|---|---|---|---|---|---|---|---|---|---|
| | MEASURE- | | MEASURE- | | MEASURE- | | MEASURE- | | MEASURE- |
| [symbol] | MENT | 1 [symbol] | MENT | [symbol] | MENT | [symbol] | MENT | [symbol] | MENT |
| Elements | Concent [symbol] | Elements | Concentration | [symbol] | Co [symbol] | [symbol] | Con [symbol] | [symbol] | Co [symbol] |
| Fe | [symbol] % | F [symbol] | [symbol] .0 [symbol] % | Fe | [symbol] .9 [symbol] % | Fe | [symbol] % | Fe | [symbol] |
| Cr | [symbol] | C [symbol] | 0. [symbol] | Cr | [symbol] | [symbol] | 10. [symbol] % | [symbol] | [symbol] |
| Ni | 1.21% | N [symbol] | 1.0 [symbol] % | [symbol] | [symbol] | [symbol] | [symbol] % | [symbol] | 7. [symbol] 0% |
| M [symbol] | [symbol] % | M [symbol] | 1.0 [symbol] % | M [symbol] | 3. [symbol] % | M [symbol] | [symbol] | M [symbol] | [symbol] |
| Co | 0. [symbol] % | C [symbol] | 0.1 [symbol] | M [symbol] | [symbol] % | M [symbol] | [symbol] | M [symbol] | [symbol] |
| Cu | 0. [symbol] % | M [symbol] | 0. [symbol] % | C [symbol] | [symbol] | [symbol] | 0. [symbol] | [symbol] | 0. [symbol] |
| Si | 0.0 [symbol] % | C [symbol] | 0.0 [symbol] | [symbol] | 0.0 [symbol] | [symbol] | 0. [symbol] | [symbol] | 0. [symbol] |
| Al | 0.11% | Si | 0. [symbol] % | [symbol] | [symbol] | [symbol] | 0. [symbol] | [symbol] | 0. [symbol] |
| W | [symbol] .0 [symbol] % | W | 0.0 [symbol] | Al | [symbol] | [symbol] | 0. [symbol] | [symbol] | 0. [symbol] |
| [symbol] | 0.04% | Al | 0. [symbol] 0% | [symbol] | [symbol] | W | 0. [symbol] | W | 0. [symbol] |
| S | [symbol] | S | 0. [symbol] % | W | [symbol] | [symbol] | 0. [symbol] | [symbol] | 0. [symbol] |
| P | 0.0 [symbol] % | | | | | | | [symbol] | [symbol] |

[symbol]

indicates data missing or illegible when filed

TABLE 13
No. SMALL PIECE 2

| 1.4932 | MEASUREMENT |
|---|---|
| Elements | Concentration |
| Fe | 73.86% |
| Cr | 13.99% |
| Ni | 7.90% |
| Mn | 1.61% |
| Mo | 1.54% |
| Cu | 0.23% |
| Sl | 0.12% |
| P | 0.16% |
| Al | 0.07% |
| V | 0.04% |

TABLE 15

| | | | | [symbol] | | [symbol] | | [symbol] | |
|---|---|---|---|---|---|---|---|---|---|
| [symbol] | | [symbol] | | | MEASURE- | | MEASURE- | | MEASURE- |
| 1.4 [symbol] 2 | M [symbol] | [symbol] | [symbol] | 1 [symbol] | MENT | 1 [symbol] | MENT | [symbol] | MENT |
| Elements | Concentration | [symbol] | [symbol] | Elements | Concentration | [symbol] | Concentration | Elements | Concentration |
| Fe | [symbol] | [symbol] | [symbol] | Fe | 75. [symbol] % | Fe | [symbol] 3. [symbol] % | Fe | 72. [symbol] % |
| Cr | [symbol] | [symbol] | [symbol] | Cr | 12. [symbol] % | Cr | 14. [symbol] % | C [symbol] | [symbol] . [symbol] % |
| [symbol] | [symbol] | [symbol] | 9. [symbol] % | [symbol] | [symbol] | [symbol] | [symbol] % | [symbol] | [symbol] 1.4 [symbol] % |
| [symbol] | [symbol] % | [symbol] | [symbol] | M [symbol] | [symbol] | M [symbol] | 1. [symbol] % | M [symbol] | [symbol] |
| M [symbol] | [symbol] .4 [symbol] % | [symbol] | [symbol] | M [symbol] | [symbol] | M [symbol] | 1.72% | M [symbol] | [symbol] |
| [symbol] | [symbol] .8 [symbol] % | [symbol] | 0. [symbol] | C [symbol] | 0. [symbol] | C [symbol] | 0.2 [symbol] % | C [symbol] | 0.2 [symbol] % |
| [symbol] | 0. [symbol] | [symbol] | 0. [symbol] | [symbol] | 0. [symbol] | [symbol] | 0. [symbol] % | [symbol] | 0.1 [symbol] % |
| [symbol] | 0. [symbol] | [symbol] | 0. [symbol] | [symbol] | 0. [symbol] | [symbol] | 0.0 [symbol] % | Al | 0.0 [symbol] % |
| [symbol] | 0. [symbol] | [symbol] | 0. [symbol] | [symbol] | 0. [symbol] | [symbol] | 0.0 [symbol] % | [symbol] | 0.0 [symbol] % |
| [symbol] | 0. [symbol] | [symbol] | 0. [symbol] | | | W | 0.0 [symbol] % | W | 0.0 [symbol] % |
| [symbol] | [symbol] | [symbol] | 0. [symbol] | | | S | 0.0 [symbol] % | S | 0.0 [symbol] % |
| [symbol] | [symbol] | [symbol] | 0. [symbol] | | | P | 0.0 [symbol] % | P | 0.0 [symbol] % |

[symbol]

indicates data missing or illegible when filed

Thus, the Applicants have synthesised some tests hereinafter:

TABLE 16

| | | | METAL | | [symbol] | [symbol] | | | |
|---|---|---|---|---|---|---|---|---|---|
| | | | EXPLOSION | METALEXPLO- | [symbol] | [symbol] | | INT [symbol] | INTERIOR |
| | | ASHES | External | SION | [symbol] | [symbol] | EXTERNAL | REACTOR [symbol] | REACTOR 2 |
| ANALYSED | NEW | [symbol] Powder | f [symbol] | [symbol] 2 | [symbol] | [symbol] | IMPACT | [symbol] | [symbol] pper |
| ELEMENT | REACTOR | REACTOR | Reactor | Reactor | Reactor | Reactor | AREA [symbol] | [symbol] | portion |
| [symbol] | (reactor 1) | 2 | [symbol] | [symbol] | [symbol] | [symbol] | Reactor 2 | [symbol] | [symbol] |
| Fe [symbol] Iron [symbol] | [symbol] | [symbol] | [symbol] | [symbol] | [symbol] | [symbol] | [symbol] | [symbol] | [symbol] |
| Cr [symbol] Chromium) | [symbol] | 0.43 | 2 [symbol] . [symbol] | 35. [symbol] | [symbol] | [symbol] | [symbol] | 27. [symbol] | [symbol] |
| Ni [symbol] Nickel) | [symbol] | 8. [symbol] | [symbol] | [symbol] 7 | [symbol] | [symbol] | 7. [symbol] | [symbol] | [symbol] |
| Mn [symbol] Manganese) | [symbol] | [symbol] .34 | 1. [symbol] | [symbol] | [symbol] | [symbol] | [symbol] | [symbol] | [symbol] |
| S [symbol] | 0 | [symbol] | 0 | 0. [symbol] | 0 | 0 | 0 | 0 | 0 |
| C [symbol] Copper) | [symbol] | [symbol] | 0. [symbol] | 0. [symbol] | 0. [symbol] | 0. [symbol] | 0. [symbol] | 8. [symbol] | 0. [symbol] |
| Si (Silicon) | 0. [symbol] | 0. [symbol] | [symbol] .21 | 0. [symbol] | 0 | 0. [symbol] | 0. [symbol] | 0. [symbol] | 0 |
| Mg (Magnesium) | 0 | [symbol] | 0 | [symbol] | 0 | 0 | 0 | 0 | 0 |
| Z [symbol] | 0 | 0.37 | 0 | 0 | 0 | 0 | 0 | 0 | 0 |
| T [symbol] (Ti [symbol] ) | 0 | 0.1 [symbol] | 0 | 0 | 0 | 0 | 0 | 0 | 0 |
| Al(Aluminum) | 0 | [symbol] | 0 | [symbol] | 0 | 0. [symbol] | 0. [symbol] | 0 | 0 |
| [symbol] (A [symbol] ) | 0 | 0. [symbol] | 0 | 0. [symbol] | 0 | 0 | 0 | 0 | 0 |
| S (Sulfer) | 0 | 0 | 0 | 0 | 0 | 0.1 [symbol] | 0 | 0 | 0 |
| P (Phosph [symbol] s) | 0 | 0 | 0 | 0 | 0 | 0 | 0 | 0 | [symbol] |
| Co (Cobalt) | 0 | 0 | 0 | 0 | 0 | 0 | 0 | 0 | [symbol] |
| M [symbol] | [symbol] | 0 | [symbol] | 0 | [symbol] | [symbol] | [symbol] 4 | [symbol] | [symbol] |
| W (Tungsten) | 0.0 [symbol] | 0 | 0 | 0 | 0 | 0.0 [symbol] | 0. [symbol] | 0. [symbol] | 0. [symbol] |
| V (Vanadium) | 0 | 0 | 0 | 0 | 0 | 0 | 0 | [symbol] | 0. [symbol] |

[symbol]

indicates data missing or illegible when filed

This synthesis shows the evolution of the percentages of the different elements already constituting the device (new reactor column) as well as the presence of new elements.

The formation of iron, the disappearance of chromium, nickel, the formation of some chemical elements such as magnesium, cobalt, titanium, phosphorus, sulphur demonstrate the presence of a fusion and transmutation reaction inside the enclosure.

The Applicants have also noticed that, during operation, particles have been emitted by the outer surfaces of the so-called reactor enclosure of the device. This emission has been detected and analysed by detecting traces of particle impact on a plastic material of the polymethyl methacrylate (PMMA) type, so-called acrylic glass.

The impact trace monitoring protocol is as follows:
Place the acrylic glass plate vertically next to the reactor and at a distance comprised between 5 and 50 cm,
The plate is heated by the thermal radiation emitted by the reactor,
Heat the plate until softening thereof,
Once the plate has softened, it can be penetrated by the particles emitted by the reactor.

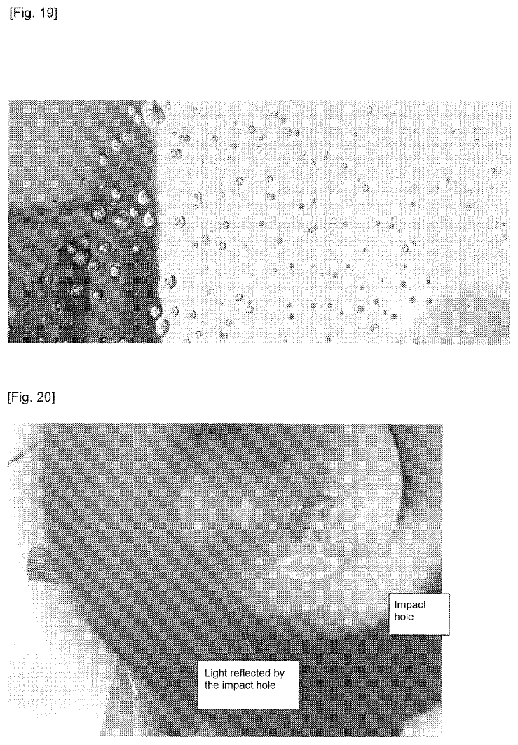

As illustrated in FIG. 19, the impact traces of these particles then appear on the plate
Once the impact traces have appeared on the plate, remove the plate from the reactor,
Lay the plate on a planar surface with the particle penetration face upwards.
Let the plate cool down until stiffening thereof.

The impact traces may be observed with a paralux and Solomark microscope. An impact hole image is illustrated by the photograph in FIG. 20. A light reflected by the impact hole appears.

These impacts have been analysed with a spectrometer on the front face and on the rear face of two plates subjected to the impacts.

The following tables give the results of these analyses.

TABLE 17
Plate No. 1 analysis

| Front face | | | |
|---|---|---|---|
| (opposite the reactor | | Rear face | |
| ELEMENTS | PPM | ELEMENTS | PPM |
| Sb | 130 | Ca | 700 |
| Sn | 60 | Sr | 9 |
| Fe | 30 | | |
| Sr | 11 | | |

Plate No. 2 analysis

| Front face | | | |
|---|---|---|---|
| (opposite the reactor) | | Rear face | |
| ELEMENTS | PPM | ELEMENTS | PPM |
| Ca | 500 | Mo | 13 |
| Ti | 27 | Fe | 23 |
| Zn | 10 | | |

It should be noted that a non-impacted PMMA plate is composed of a mineral and metallic substance of calcium (Ca) at 500 PPM (parts per million).

Since chromium and nickel are not detected, it could be concluded that the increase in iron concentration is not related to a phenomenon of evaporation of the other elements.

The Applicants have also analysed the radiations emitted by the external walls of the so-called reactor enclosure during operation by means of a neutron and x-ray gamma detector (R60N with an N10 probe) as well as by means of a beta, gamma, etc., radiation detector.

Measurements of the emitted radiation (beta, gamma, x-rays and neutrons) show values lower than 0.3 microsieverts per hour. Thus, no hazardous radiation is detected outside the reactor

With regards to the analyses hereinabove, the Applicants have imagined an application of the device of the invention for the purpose of synthesising iridium and rhodium.

This synthesis is done starting from a lead-bismuth plate with a lead concentration of 90% and a bismuth concentration of 10% arranged in the enclosure or accessible from the latter so as to subject it to the jet of the second gas under the following conditions: used fuel: Ethanol at 97% at 6 Kg/h and jet-forming gas composition: Air (80 l/min)+oxygen (20 l/min).

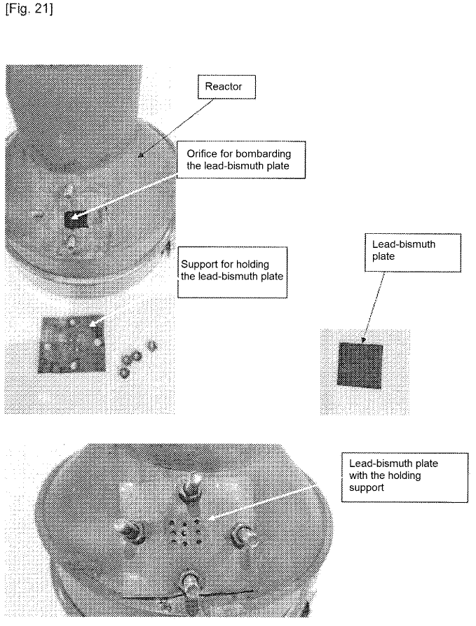

To implement this application, the wall of the enclosure has been pierced at the impact area of the jet and the lead plate has been arranged to seal off the created hole so that the jet of the second gas is brought to impact said plate which is associated with a mounting for holding in position to hold it in place on the external surface of the enclosure above the hole. This set-up is illustrated by the photographs in FIG. 21.

After operation of the device, under the effect of the bombardment, the lead-bismuth plate melts down and gives a plurality of samples.

The analysis of these samples by spectrometry gives the following results:

TABLE 18

| | | | | | | | Re [symbol] | Re [symbol] |
|---|---|---|---|---|---|---|---|---|
| | Concentration | | [symbol] | Concentration | Concentration | | [symbol] | [symbol] |
| | [symbol] n the sample | Concentration | concentration | in the treated | in [symbol] | [symbol] rice | [symbol] | [symbol] |
| | before treatment | [symbol] | in the treated | sample | [symbol] | [symbol] | [symbol] | [symbol] |
| | [symbol] | sample [symbol] | sample [symbol] | [symbol] | [symbol] | [symbol] | [symbol] | [symbol] |
| Iron (Fe) | 0 | 0- [symbol] 97 | 2.98 | | | | | |
| Rubiduim (Rb) | 0 | 0.2 [symbol] 6-0.37 [symbol] | 0. [symbol] 3 | | | | | |
| [symbol] odium ( [symbol] ) | 0 | 0 [symbol] -0 [symbol] | [symbol] | [symbol] | 1.5 | [symbol] | [symbol] | [symbol] |
| [symbol] | 0 | [symbol] -8. [symbol] | [symbol] | [symbol] | [symbol] | [symbol] | [symbol] | [symbol] |
| Lead (Pb) | 90 | 24. [symbol] - [symbol] .57 | [symbol] | | | | | |
| Bismuth (Bi) | 10 | [symbol] . [symbol] 7- [symbol] . [symbol] | 1 [symbol] . [symbol] | | | | | |
| | | | | | | Total | [symbol] | 10 [symbol] |

[symbol]

indicates data missing or illegible when filed

Thus, it appears that rhodium and iridium have actually been synthesised from the bombardment implemented by the device of the invention of a plate of lead associated with bismuth. Rhodium and iridium are formed by transmutation of lead and bismuth. The concentration of the produced rhodium (0.297-0.44%) or an average of 3,700 g/tonne of sample is 2,466 times higher than the average concentration of rhodium in natural ores (1 g/tonne of minerals). The concentration of the produced iridium (6.16-8.42%) or an average of 73,000 g/tonne of sample is 48,600 times higher than the average concentration of iridium in natural ores (1 g/tonne of ores).

The details of the twelve results of the analysis carried out on twelve faces by spectrometry are given hereinbelow.

| | | | | | |
|---|---|---|---|---|---|
| NA | Symb | line | intensity | concentration | uncertainity |

1B-020-F1

| | | | | | |
|---|---|---|---|---|---|
| 20 | Ca | K | 66 | 0.723 | 0.940 |
| 22 | Ti | K | 108 | 0.400 | 0.307 |
| 23 | V | K | 28 | 0.064 | 0.185 |
| 26 | Fe | K | [symbol] | 0.350 | 0.072 |
| 30 | Zn | K | 28 | 0.005 | 0.029 |
| 37 | Rb | K | 2877 | 0.378 | 0.068 |
| 42 | Mo | K | 294 | 0.040 | 0.013 |
| 45 | Rh | K | 1931 | 0.297 | 0.025 |
| 77 | Ir | L | 33112 | 8.424 | 0.094 |
| 82 | Pb | L | 449766 | 76.794 | 0.214 |
| 83 | Bi | L | 80616 | 12.523 | 0.259 |

1B-020-F2

| | | | | | |
|---|---|---|---|---|---|
| 20 | Ca | K | 63 | 0.664 | 0.929 |
| 22 | Ti | K | 111 | 0.402 | 0.295 |
| 26 | Fe | K | 483 | 0.283 | 0.064 |
| 37 | Rb | K | [symbol] | 0.363 | 0.068 |
| 42 | Mo | K | 326 | 0.042 | 0.032 |
| 45 | Rh | K | 1904 | 0.282 | 0.024 |
| 51 | Sb | K | 141 | 0.033 | 0.033 |
| 77 | Ir | L | 32004 | 7.808 | 0.089 |
| 82 | Pb | L | [symbol] | 77.759 | 0.202 |
| 83 | [symbol] | L | 82820 | 12.363 | 0.256 |

2B-020-F1

| | | | | | |
|---|---|---|---|---|---|
| 20 | Ca | K | 59 | 0.658 | 0.926 |
| 24 | Cr | K | 45 | 0.068 | 0.111 |
| 26 | Fe | K | 468 | 0.288 | 0.067 |
| 28 | [symbol] | K | [symbol] | 0.008 | 0.082 |
| 37 | Rb | K | 2423 | 0.324 | 0.069 |
| 42 | Mo | K | 125 | 0.017 | 0.010 |
| [symbol] | [symbol] | K | 1597 | 0.249 | 0.022 |
| 77 | Ir | L | [symbol] | [symbol] | 0.091 |
| 82 | Pb | L | 456681 | [symbol] | 0.199 |
| 83 | Bi | L | 74101 | 11.656 | 0.247 |

[symbol]

| | | | | | |
|---|---|---|---|---|---|
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |

1CA-020-F1

| | | | | | |
|---|---|---|---|---|---|
| 20 | [symbol] | K | [symbol] | [symbol] | [symbol] |
| 22 | Ti | K | [symbol] | [symbol] | [symbol] |
| [symbol] | Mn | K | [symbol] | [symbol] | [symbol] |
| [symbol] | Fe | K | [symbol] | [symbol] | [symbol] |
| 28 | Ni | K | [symbol] | [symbol] | [symbol] |
| 37 | [symbol] | K | [symbol] | [symbol] | [symbol] |
| 42 | Mo | K | [symbol] | [symbol] | [symbol] |
| 45 | [symbol] | K | [symbol] | [symbol] | [symbol] |
| [symbol] | [symbol] | K | [symbol] | [symbol] | [symbol] |
| 77 | [symbol] | L | [symbol] | [symbol] | [symbol] |
| 82 | [symbol] | L | [symbol] | [symbol] | [symbol] |
| 83 | [symbol] | L | [symbol] | [symbol] | [symbol] |

1CA-020-F2

| | | | | | |
|---|---|---|---|---|---|
| 20 | [symbol] | K | [symbol] | [symbol] | [symbol] |
| 22 | [symbol] | K | [symbol] | [symbol] | [symbol] |
| 24 | [symbol] | K | [symbol] | [symbol] | [symbol] |
| [symbol] | [symbol] | K | [symbol] | [symbol] | [symbol] |
| [symbol] | [symbol] | K | [symbol] | [symbol] | [symbol] |
| 28 | [symbol] | K | [symbol] | [symbol] | [symbol] |
| 37 | [symbol] | K | [symbol] | [symbol] | [symbol] |
| 42 | [symbol] | K | [symbol] | [symbol] | [symbol] |
| 45 | [symbol] | K | [symbol] | [symbol] | [symbol] |
| 77 | [symbol] | L | [symbol] | [symbol] | [symbol] |
| 82 | [symbol] | L | [symbol] | [symbol] | [symbol] |
| 83 | [symbol] | L | [symbol] | [symbol] | [symbol] |

2CA-020-F1

| | | | | | |
|---|---|---|---|---|---|
| 20 | Ca | K | 81 | 0.923 | 0.864 |
| 22 | Ti | K | 64 | 0.248 | 0.278 |
| 23 | [symbol] | K | 28 | 0.070 | 0.173 |
| 24 | Cr | K | 47 | 0.068 | 0.121 |
| 25 | Mn | K | 34 | 0.033 | 0.080 |
| 26 | Fe | K | 1394 | 0.888 | [symbol] |
| 28 | Ni | K | 31 | 0.010 | 0.033 |
| 37 | Rb | K | 2283 | 0.313 | 0.073 |
| 42 | Mo | K | 152 | 0.022 | 0.009 |
| 45 | Rh | K | 1594 | 0.256 | 0.021 |
| 49 | In | K | 52 | 0.011 | 0.023 |
| 77 | Ir | L | [symbol] | [symbol] | [symbol] |
| 82 | [symbol] | L | [symbol] | 78.164 | 0.221 |
| 83 | Bi | L | [symbol] | 12.490 | [symbol] |

2CA-020-F2

| | | | | | |
|---|---|---|---|---|---|
| 20 | Ca | K | 56 | 0.607 | 0.845 |
| 22 | Ti | K | 48 | 0.177 | 0.298 |
| 24 | [symbol] | K | 201 | 0.278 | 0.125 |
| 25 | Mn | K | [symbol] | 0.126 | [symbol] |
| 26 | Fe | K | 9729 | 5.947 | 0.155 |
| 28 | [symbol] | K | 258 | 0.081 | [symbol] |
| 37 | Rb | K | [symbol] | 0.285 | 0.062 |
| 42 | Mo | K | 163 | 0.022 | 0.009 |
| 45 | [symbol] | K | 1612 | 0.245 | 0.019 |
| 49 | [symbol] | K | 54 | 0.011 | 0.021 |
| 77 | [symbol] | L | [symbol] | 6.302 | 0.083 |
| 82 | [symbol] | L | [symbol] | [symbol] | 0.206 |
| 83 | Bi | L | [symbol] | [symbol] | 0.241 |

[symbol]

-020-F1

| | | | | | |
|---|---|---|---|---|---|
| 20 | Ca | K | 42 | 0.482 | 0.950 |
| 22 | Ti | K | 37 | 0.142 | 0.294 |
| 24 | Cr | K | 254 | 0.366 | 0.135 |
| 25 | Mn | K | 53 | 0.051 | 0.091 |
| 26 | Fe | K | 1386 | 0.882 | 0.084 |
| 28 | Ni | K | 49 | 0.015 | 0.034 |
| 37 | Rb | K | 2161 | 0.298 | 0.064 |
| 42 | Mo | K | 114 | 0.016 | 0.009 |
| 45 | [symbol] | K | 1526 | 0.245 | 0.020 |
| 51 | Sb | K | 79 | 0.020 | 0.027 |
| 77 | Ir | L | 26468 | 7.039 | 0.089 |
| 82 | Pb | L | 442510 | 79.184 | 0.192 |
| 83 | Bi | L | [symbol] | 11.259 | 0.251 |

[symbol]

-020-F2

| | | | | | |
|---|---|---|---|---|---|
| 20 | Ca | K | 43 | 0.484 | 0.935 |
| 22 | Ti | K | 79 | 0.302 | 0.302 |
| 23 | V | K | 31 | 0.072 | 0.170 |
| 26 | Fe | K | 61 | 0.039 | 0.056 |
| 45 | Rh | K | 1706 | 0.272 | 0.020 |
| 77 | Ir | L | 30085 | 7.886 | 0.090 |
| 82 | Pb | L | 484395 | 85.577 | 0.186 |
| 83 | Bi | L | 33474 | 5.370 | 0.249 |

1PE-020-F1

| | | | | | |
|---|---|---|---|---|---|
| 22 | Ti | K | 42 | 0.173 | 0.316 |
| 26 | Fe | K | 83 | 0.056 | 0.063 |
| 27 | Co | K | 33 | 0.016 | 0.045 |
| 28 | Ni | K | 33 | 0.011 | 0.032 |
| 37 | Rb | K | 2290 | 0.333 | 0.070 |
| 42 | Mo | K | 62 | 0.009 | 0.008 |
| 45 | Rh | K | 1427 | 0.244 | 0.021 |
| 77 | Ir | L | 25378 | 7.084 | 0.092 |
| 82 | Ph | L | 421350 | 79.447 | 0.158 |
| 83 | Bi | L | 73606 | 12.627 | 0.261 |

1PE-020-F2

| | | | | | |
|---|---|---|---|---|---|
| 20 | Ca | K | 52 | 0.397 | 0.940 |
| 22 | Ti | K | 63 | 0.247 | 0.295 |
| 25 | Mn | K | 32 | 0.031 | 0.075 |
| 26 | Fe | K | 94 | 0.061 | 0.064 |
| 37 | Rb | K | 2058 | 0.286 | 0.067 |
| 42 | Mo | K | 70 | 0.010 | 0.009 |
| 45 | Rh | K | 1546 | 0.252 | 0.021 |
| 51 | Sb | K | 52 | 0.013 | 0.028 |
| 77 | Ir | L | 23053 | 6.161 | 0.085 |
| 82 | Pb | L | 441910 | 79.873 | 0.197 |
| 83 | Bi | L | 75844 | 12.469 | 0.254 |

[symbol]

indicates data missing or illegible when filed

It appears in these results that the device of the invention produces chemical elements at a concentration higher than that which is found in natural and therefore without extraction.

It should be understood that the method and the devices that have just been described and shown hereinabove have been disclosed for the purpose of disclosure rather than limitation. Of course, various arrangements, modifications and improvements could be made to the examples hereinabove, yet without departing from the scope of the invention.

1. A method for energy production and chemical element synthesis, the method comprising:
providing an enclosure comprising walls with internal and external surfaces,
providing a first hot gas or gaseous mixture inside the enclosure,
providing in the form of a jet inside the enclosure a second gas or gaseous mixture under pressure whose temperature is lower than that of the first gas or gaseous mixture in the enclosure,
Accelerating the second gas or gaseous mixture through a sudden increase in their temperature when the jet comes out into the heated enclosure,
Ionising the jet of the second gas or gaseous mixture by friction between the gas jet of the second gas or gaseous mixture and the first hot gas or gaseous mixture contained in the enclosure, the ionisation creating a first plasma,
Projecting the jet of the second ionised gas or gaseous mixture on the internal surface of a wall of the enclosure so as to form a swirling area of ionised gas at the periphery of the impact area of the jet of second gas on the wall of the enclosure,
Creating shocks and collisions between the molecules and atoms of the jet of the second gas or gaseous mixture and the atoms of the material forming the impact area and its periphery with:
a diffusion of part of the atoms and gas projected inside the material forming the impact area and its periphery with a creation of shocks and collisions between the molecules and atoms and the nuclei of the atoms of the jet of the second gas or gaseous mixture and the atoms and the nuclei of the atoms of the material composing the impact area and its periphery,
a creation of secondary jets of a second hot plasma in the form of an ionised gas containing atoms of the material composing the impact area and its periphery and the atoms and molecules derived from the jet of the second gas or gaseous mixture,
a projection of the secondary jets of the plasma on the walls of the enclosure inside the latter with a creation of shocks and collisions between the molecules, atoms and nuclei of the atoms of the gas jets and the atoms and nuclei of the atoms of the material composing the enclosure,
Creating transmutation reactions and,
depending on the material of the impact area and its periphery, creating nuclear fusion reactions, and
synthesising chemical elements resulting from the shocks and collisions between the molecules, atoms and nuclei of the atoms of the gas jets and the atoms and nuclei of the atoms of the material of the impact area and its periphery defined in the enclosure.

2. The method according to claim 1, wherein the method reproduces conditions equivalent to those of a black hole.

3. The method according to claim 1, wherein the energy created is in the form of:
Thermal radiation,
Heat,
Light radiation or light (visible, infrared, ultraviolet, X-rays),
Alpha and/or beta and/or gamma radiation,
Plasma,
Photons,
Charged particles,
Uncharged particles,
Neutrons,
Combustion gas.

4. The method according to claim 2, wherein the energy is extracted in:
Electrical energy,
Mechanical energy,
Heat.

5. The method according to claim 1, wherein at least one of the following chemical elements Fe, Co, Sb, Sn, Sr, P, S, Ti, Mg, Zn, Al, V, Ti, Ir, Rh, Rb, is synthesised.

6. The method according to claim 1, wherein the second gas forming the jet(s) (fresh or hot gas coming out of the jet nozzle) is selected from the following list:
air,
oxygen,
nitrogen,
carbon monoxide,
carbon dioxide,
argon,
helium,
hydrogen,
deuterium,
tritium.

7. The method according to claim 6, wherein the second gas is formed by any other gas or mixture of at least two of the gases listed hereinabove.

8. The method according to claim 1, wherein the material of the enclosure is selected from thermally and/or electrically conductive metals or metal alloys. These choices are made to promote these reactions.

9. The method according to claim 1, wherein an element made of a material different from that of the walls of the enclosure is positioned at the impact area.

10. The method according to claim 1, wherein when the materials of the walls of the enclosure undergoing the impact or of the element positioned in the impact area contain chemical elements heavier than iron, nuclear fission reactions of these heavy elements take place.

11. The method according to claim 1, wherein the content of the enclosure undergoes a heating before introduction of the second gas or gaseous mixture.

12. The method according to claim 11, wherein this heating is implemented by at least one following method:
from the inside,
from the outside,
By any heating means including electrical means.

13. The method according to claim 12, wherein the electricity for the electric heating originates from solar panels and/or wind turbines.

14. The method according to claim 1, wherein the first hot gas or gaseous mixture results from a combustion carried out in the enclosure.

15. The method according to claim 14, wherein the enclosure is fed with one or more liquid or gaseous fuel(s).

16. The method according to claim 14, wherein when combustion is implemented in the enclosure, the jet of second gas or gaseous mixture is brought into contact with the combustion flame are used.

17. The method according to claim 1, wherein the enclosure is equipped with at least one discharge duct.

18. The method according to claim 17, wherein one or more jet(s) of fresh or hot air is/are complementarily arranged to the discharge duct for feeding another enclosure.

19. The method according to claim 1, wherein the wall on which the impact took place consists of a powder or particles or microparticles of conductive metals or metal alloys. This structure of the material promotes the desired reactions.

20. A device allowing implementing the method according to claim 1, further comprising an enclosure comprising a wall equipped with inlet orifices with,
At least one inlet orifice for a first hot gas or gaseous mixture or for a fuel the combustion of which produces a first hot gas or gaseous mixture,
at least one projection nozzle in the form of a jet of a second gas or gaseous mixture under pressure and whose temperature is lower than that of the first gas or gaseous mixture,
said nozzle being directed towards the internal surface of one of the walls forming the enclosure so that the jet of second gas or gaseous mixture hits the wall.

21. The device according to claim 20, wherein the enclosure comprises at least one inlet orifice for a liquid or solid or combustible gas or gas resulting from the combustion of fossil or non-fossil fuels;

22. The device according to claim 20, wherein the enclosure comprises at least one outlet orifice for ionised gas or plasma and for combustion gases when a combustion is carried out.

23. The device according to claim 20, wherein the wall or the element subject to the impact of the jet is inclined with respect to the axis of the jet.

24. The device according to claim 20, wherein the axis of the jet of the second gas or gaseous mixture is inclined by a given angle with respect to the axis perpendicular to the surface of the impact area of the jet.

25. The device according to claim 20, wherein the material of the wall of the enclosure is selected from the following list:
304 stainless steel,
316 stainless steel,
iron or iron alloy,
nickel or nickel alloy,
chromium or chromium alloy,
bismuth or bismuth alloy,
lead or lead alloy,
aluminium or aluminium alloy.

26. The device according to claim 25, wherein the aluminium or aluminium alloy is coated over its internal and/or external face with a polytetrafluoroethylene (PTFE) coating.

27. The device according to claim 20, wherein a plate made of lead and bismuth is arranged in the impact area of the gas jet so as to form iridium and rhodium.
